(19) United States
(12) Patent Application Publication
(10) Pub. No.: US 2014/0152026 A1
(43) Pub. Date: Jun. 5, 2014

(54) CONFIGURABLE LATCH ASSEMBLY

(71) Applicant: Omar Cinco, Farmington Hills, MI (US)

(72) Inventor: Omar Cinco, Farmington Hills, MI (US)

(21) Appl. No.: 13/690,042

(22) Filed: Nov. 30, 2012

(51) Int. Cl. E05B 65/12

(52) U.S. Cl. CPC E05B 83/28
USPC 292/158; 292/139

(57) ABSTRACT

A modular latch assembly for selectively securing a cover member to a base due to actuation of an input member is disclosed. The latch assembly includes an arm that is supported for substantially linear movement between a latched position and an unlatched position. The arm secures the cover member to the base when in the latched position, and the arm releases the cover member from the base when in the unlatched position. Moreover, the latch assembly includes a link that is operably coupled to the arm for rotation relative to the arm simultaneously as the arm moves between the latched and unlatched positions. The arm and the link have a first modular configuration in which the input member engages the arm for unlatching the assembly and a second modular configuration in which the input member engages the link for unlatching the assembly.

### FIELD

The present disclosure relates to a latch assembly and, more particularly, relates to a configurable latch assembly that can be configured in various ways for selectively latching a cover member to a base structure.

### BACKGROUND

Glove boxes, cup holders, cargo areas, and other areas within a vehicle can include a base structure that defines a cavity and a cover member or door that can move between an open position and a closed position relative to the base structure. In the open position, the cover member can be positioned away from the base, thereby revealing the contents of the cavity. In the closed position, the cover member can be positioned adjacent the base structure, thereby covering the cavity. In some embodiments, the cover member can be pivotally coupled to the base structure, for instance, via a hinge or other hardware.

Moreover, a latch assembly can be included for selectively securing the cover member to the base in the closed position. The latch assembly can have a latched position, wherein the latch assembly secures the cover member to the base, and the latch assembly can also have an unlatched position, wherein the latch assembly releases the cover member from the base.

### SUMMARY

A modular latch assembly for selectively securing a cover member to a base due to actuation of an input member is disclosed. The input member includes an input engagement member. The latch assembly includes an arm that is supported for substantially linear movement between a latched position and an unlatched position. The arm secures the cover member to the base when in the latched position, and the arm releases the cover member from the base when in the unlatched position. The arm includes an arm engagement member. Moreover, the latch assembly includes a link that is operably coupled to the arm for rotation relative to the arm simultaneously as the arm moves between the latched and unlatched positions. The link includes a link engagement member. The arm and the link have a first modular configuration in which the arm engagement member is configured to engage the input engagement member due to selective actuation of the input member, thereby resulting in simultaneous movement of the arm between the latched and unlatched positions and rotation of the link. The arm and the link also have a second modular configuration in which the link engagement member is configured to engage the input engagement member due to selective actuation of the input member, thereby resulting in simultaneous movement of the arm between the latched and unlatched positions and rotation of the link.

Moreover, a modular latch assembly for selectively securing a cover member to a base due to actuation of an input member is disclosed. The input member includes an input engagement member. The latch assembly includes a first arm and a second arm that are supported for substantially linear movement in different directions between a latched position and an unlatched position. The first and second arms secure the cover member to the base when in the latched position, and the first and second arms release the cover member from the base when in the unlatched position. At least one of the first and second arms includes an arm engagement member. Moreover, the latch assembly includes a link that is operably coupled to the first and second arms for rotation relative to the first and second arms simultaneously as the first and second arms move between the latched and unlatched positions. The link includes a link engagement member. The first and second arms and the link have a first modular configuration in which the arm engagement member is configured to engage the input engagement member due to selective actuation of the input member, thereby resulting in simultaneous movement of the first and second arms between the latched and unlatched positions and rotation of the link. The first and second arms and the link also have a second modular configuration in which the link engagement member is configured to engage the input engagement member due to selective actuation of the input member, thereby resulting in simultaneous movement of the first and second arms between the latched and unlatched positions and rotation of the link.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1A is a plan view of a cover member that is selectively secured to a base structure via a modular latch assembly according to various exemplary embodiments of the present disclosure;

FIG. 1B is a perspective view of the cover member of FIG. 1A shown released from the base structure;

FIG. 2 is a partially exploded view of the modular latch assembly of FIG. 1A;

FIGS. 3A and 3B are perspective views of the modular latch assembly in a first modular configuration, wherein a rotatably mounted input member engages an arm of the latch assembly, and wherein FIG. 3A shows the latch assembly in a latched position and FIG. 3B shows the latch assembly in an unlatched position;

FIG. 4, 5A, and 5B are views of the latch assembly shown in a second modular configuration, wherein a rotatably mounted input member engages a link of the latch assembly, wherein FIG. 4 is a plan view of the latch assembly, wherein FIG. 5A is a sectional view of the latch assembly in the latched position and FIG. 5B is a sectional view of the latch assembly in the unlatched position;

FIGS. 6A and 6B are schematic views of the modular latch assembly in a third modular configuration, wherein a linearly moveable input member engages the link, and wherein FIG. 6A shows the latch assembly in a latched position and FIG. 6B shows the latch assembly in an unlatched position;

FIGS. 7A and 7B are schematic views of the modular latch assembly in a fourth modular configuration, wherein a linearly moveable input member engages the arm, and wherein FIG. 7A shows the latch assembly in a latched position and FIG. 7B shows the latch assembly in an unlatched position;

FIGS. 8, 9A, and 9B are schematic views of the modular latch assembly in a fifth modular configuration, wherein a linearly moveable input member engages the arm, and wherein FIG. 8 is a plan view of the latch assembly, FIG. 9A is a section view of the latch assembly in a latched position, and FIG. 9B is a section view of the latch assembly in an unlatched position.

### DETAILED DESCRIPTION

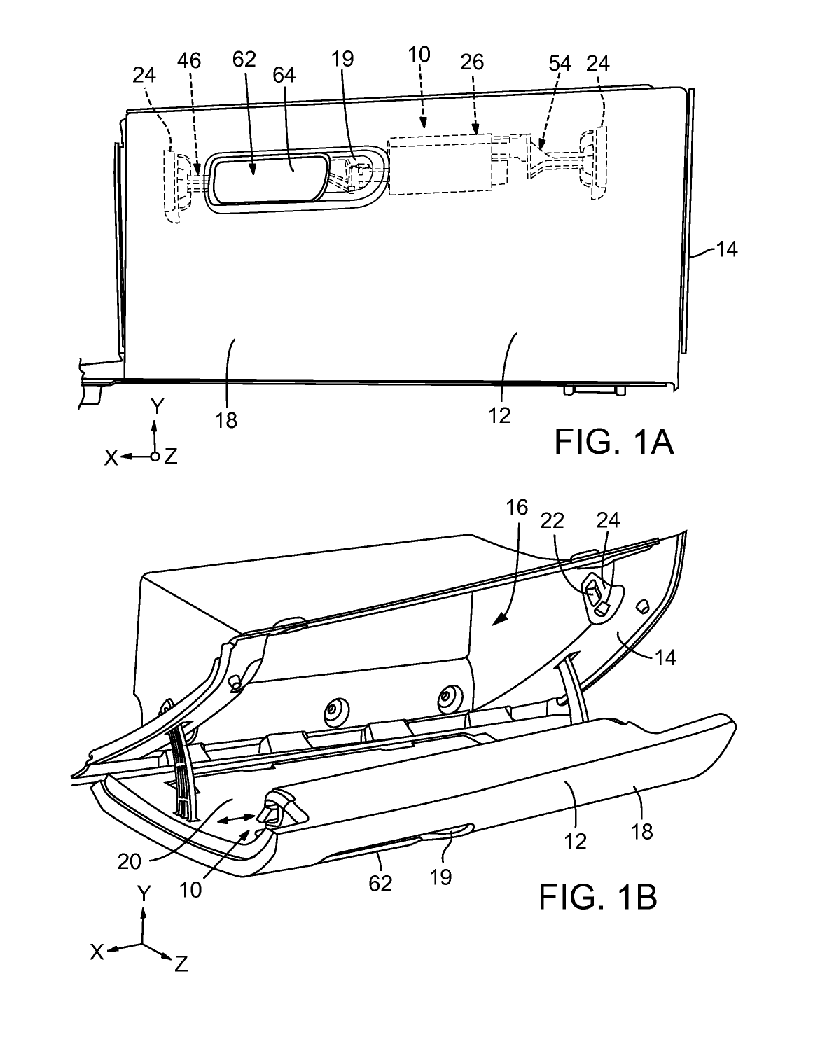

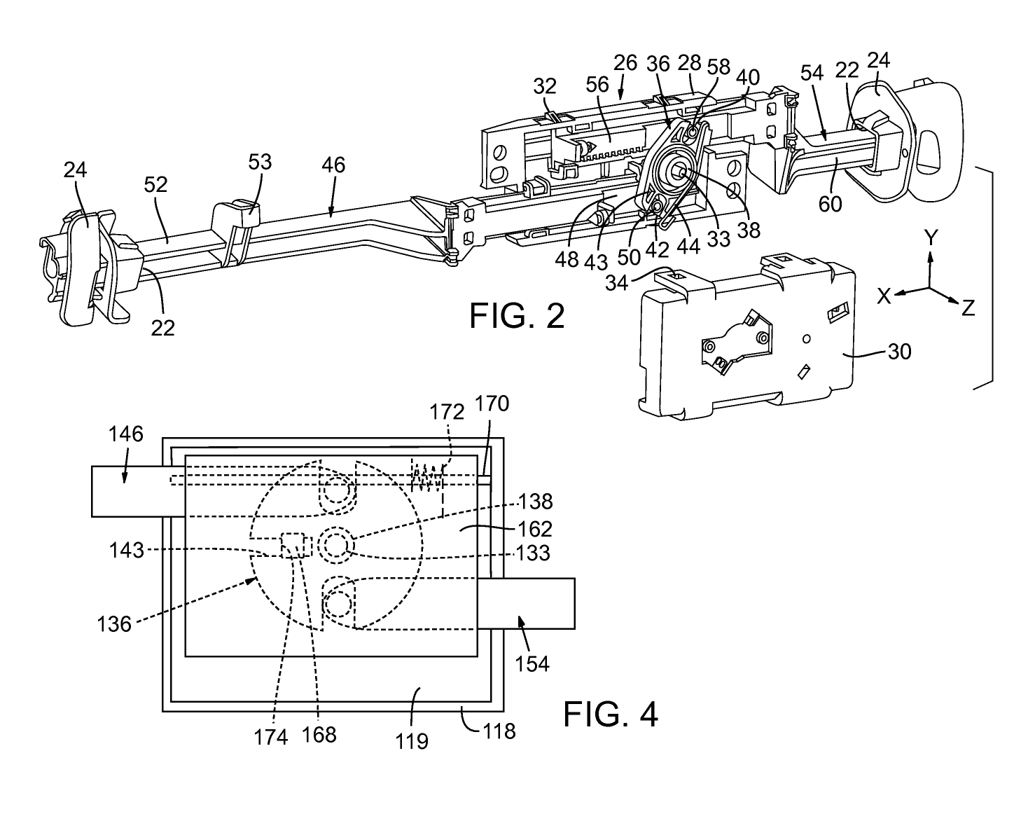

Referring initially to FIGS. 1A, 1B, and 2, a latch assembly 10 is illustrated according to exemplary embodiments of the present disclosure. The latch assembly 10 can be used for selectively securing a cover member 12 to a base 14. In the embodiments illustrated, the latch assembly 10, cover member 12, and base 14 collectively define a glove box of a vehicle (e.g., a car, truck, van, sports utility vehicle, etc.). The latch assembly 10 can include components that are disposed within a Cartesian coordinate system, which is defined by the vehicle. In the embodiments illustrated, an X-axis (pitch axis) can be defined in the cross-vehicle direction, a Y-axis (yaw axis) can be defined in the vertical direction, and a Z-axis (pitch axis) can be defined in the fore/aft direction.

It will be appreciated that the latch assembly 10, cover member 12, and base 14 can define another type of container other than a glove box. For instance, these components can define a rear cargo box, a cup holder, etc., of a vehicle. Also, the latch assembly 10, cover member 12, and base 14 could be associated with a container that is not associated with a vehicle.

In some embodiments, the cover member 12 includes an outer panel 18 that defines a recess 19 (FIG. 1B). The cover member 12 can also include an inner panel 20 that is fixed to and that overlaps the outer panel 18. The base 14 can be hollow so as to define a cavity 16 therein. The cover member 12 can be moveably (e.g., hingeably) attached to the base 14 so as to move between a closed position (FIG. 1A) and an open position (FIG. 1B).

The base 14 can also include at least one opening 22, which is defined in a respective block 24 as shown in FIG. 1B. In the embodiments shown, there are two blocks 24 and each includes a respective opening 22; however, it will be appreciated that there can be any number of blocks 24 with any number of respective openings 22.

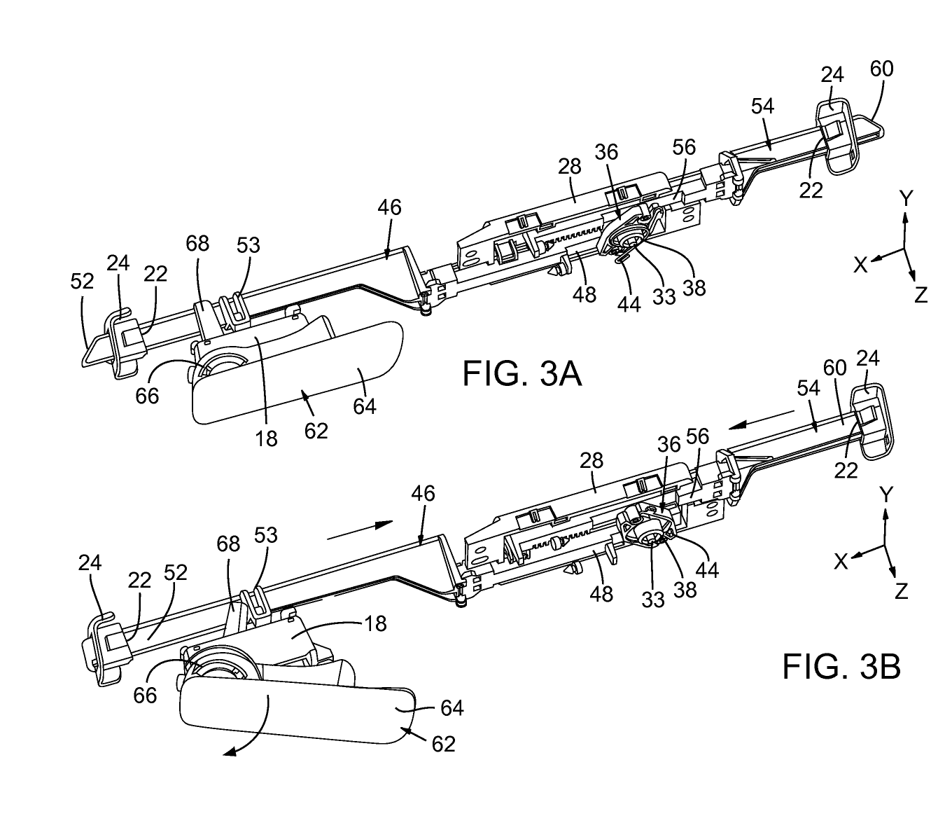

The latch assembly 10 can be mounted substantially between the inner and outer panels 18, 20 of the cover member 12 as will be discussed in detail below. Also, as will be discussed, the latch assembly 10 can have a latched position (FIGS. 1A, 2), wherein respective parts of the latch assembly 10 are removably received within the openings 22 of the base 14, such that the cover member 12 is secured to the base 14. The latch assembly 10 can also include an unlatched position (e.g., FIG. 3B), wherein those parts of the latch assembly 10 are positioned outside of the openings 22 of the base 14, such that the cover member 12 is released from the base 14.

An input member 62 can also be included for selectively moving the latch assembly 10 between the latched and unlatched positions as will be discussed. The input member 62 can be of any suitable type, such as a lever, handle, button, slider, etc. Also, the input member 62 can be moveably mounted to the cover member 12. Thus, assuming that the cover member 12 is in the closed position over the base 14, and the latch assembly 10 is in the latched position (FIG. 1A), the user can actuate (e.g., rotate, push, pull, slide, etc.) the input member 62 to thereby move the latch assembly 10 to the unlatched position.

As will be discussed in detail below, the latch assembly 10 can have several modular configurations. As such, the latch assembly 10 can accommodate various types of the input members 62. Also, the latch assembly 10 can be modularly configured to accommodate input members 62 that are mounted to the cover member 12 in a variety of ways. In each of these configurations, many parts of the latch assembly 10 can be the same in each modular configuration. Thus, the latch assembly 10 can be manufactured and assembled in a very efficient manner. For instance, tooling (e.g., molds) can be the same for each configuration, which can reduce manufacturing costs. Also, assembly of the latch assembly 10 in each configuration can be largely the same, resulting in greater efficiencies.

Referring now to FIG. 2, the latch assembly 10 will be discussed in detail. As shown, the latch assembly 10 can include a housing 26 that includes a first member 28 and a second member 30 that can be removably and fixedly attached. Specifically, the first member 28 can include projections 32 that can be received by resilient clips 34 of the second member 30 for removably attaching the first and second members 28, 30. When attached, the first and second members 28, 30 can collectively define a hollow box with a plurality (e.g., six) flat sides. Also, as shown in FIG. 2, the first member 28 can include a relatively small, cylindrical post 33 that projects toward the second member 30.

The latch assembly 10 can further include a link 36. In the embodiments of FIG. 2, the link 36 is somewhat diamond-shaped in the X-Y plane, but the link 36 can be circular, or can have any other suitable shape. The link 36 can include an annular hub 38 that is centrally located on the link 36. As shown in FIG. 2, the hub 38 can receive the post 33 of the housing 26 such that the link 36 can rotate relative to the housing 26. For instance, the link 36 can rotate about the axis of the hub 38 (i.e., the link axis of rotation). In the embodiments illustrated, this axis of rotation is substantially parallel to the Z-axis.

The link 36 can also include a first opening 40 and a second opening 42. The openings 40, 42 can be notches, slots, grooves, or any other type. The openings 40, 42 can be spaced 180 degrees apart from one another about the hub 38, and the openings 40, 42 can be spaced radially from the hub 38 at substantially equal distances.

Moreover, the link 36 can include at least one link engagement member 43. In the embodiments illustrated, the link engagement member 43 is a recessed surface, hole, or other opening formed therein. The link engagement member 43 can be radially spaced from the hub 38 and can be circumferentially spaced from the second opening 42. It will be appreciated that the link engagement member 43 can also be a projection or other object in some embodiments. As will be discussed in detail below, the link 36 can rotate when the latch assembly 10 moves between the latched and unlatched positions. Also, as will be discussed, the link assembly 10 can be configured so that the link engagement member 43 engages with the input member 62. Accordingly, actuation of the input member 62 can drive rotation of the link 36 such that the latch assembly 10 moves between the latched and unlatched positions.

Additionally, the latch assembly 10 can include a biasing member 44. The biasing member 44 can be of any suitable type, such as a leaf-spring or other resilient member. As shown in FIG. 2, the biasing member 44 can be fixed at one end to the first member 28 of the housing 26, can extend along one side of the link 36, and can terminate adjacent the second opening 42. In some embodiments, the position of the link 36 shown in FIG. 2 (e.g., corresponding to the latched position of the latch assembly 10) can be a neutral position of the link 36, and the biasing member 44 can rotatably bias the link 36 toward this position. Thus, the biasing member 44 can bias the latch assembly 10 toward the latched position in some embodiments.

Furthermore, the latch assembly 10 can include at least one arm 46, 54 that is operably coupled to the link 36 for linear movement that occurs simultaneously and/or as a result of rotation of the link 36. Specifically, in the embodiments illustrated, there is a first arm 46 and a second arm 54. Each arm 46, 54 can be elongate. As such, the first arm 46 can include a first end 48 and a second end 52. The first end 48 can be adjacent the link 36 and can include a post 50 that is moveably received within the second opening 42 of the link 36. The second end 52 can extend out of the housing 26 and can terminate adjacent one of the openings 22 in the base 14. Similarly, the second arm 54 can include a first end 56 and a second end 60. The first end 56 can be adjacent the link 36 and can include a post 58 that is moveably received within the first opening 40 of the link 36. The second end 60 can extend out of the housing 26 (in a direction opposite that of the first arm 46), and the second end 60 can terminate adjacent the other opening 22 in the base 14. In the latched position, the second ends 52, 60 of the arms 46, 54 can be received within the openings 22 to secure the cover member 12 to the base 14. In the unlatched position, the second ends 52, 60 can be moved out of the openings 22 to release the cover member 12 from the base 14.

Accordingly, both the first and second arms 46, 54 can move linearly relative to the openings 22 in the base 14 to move between the latched and unlatched positions. In the embodiments illustrated, both the first and second arms 46, 54 can move substantially parallel to the X-axis, albeit in opposite linear directions. Also, as should be apparent, the arms 46, 54 can move linearly while the link 36 rotates about its axis. Moreover, linear movement of one of the arms 46, 54 can cause rotation of the link 36 as well as linear movement of the other arm 46, 54. On the other hand, rotation of the link 36 can cause linear movement of both arms 46, 54. Furthermore, the biasing member 44 can bias the link 36, thereby biasing the arms 46, 54 toward the latched position. The latch assembly 10 can additionally include bumpers or other objects or surfaces that limit linear movement of the arms 46, 54 (e.g., when the arms 46, 54 reach the unlatched position and/or when the arms 46, 54 reach the latched position).

In the embodiments illustrated in FIG. 2, the first arm 46 can include an arm engagement member 53. The arm engagement member 53 can be a projection that extends transversely from the second end 52 of the arm 46 as shown. In additional embodiments, the arm engagement member 53 can be a recess, a hole, or other opening defined in the arm 46. Also, it will be appreciated that the arm engagement member 53 could be included on the second arm 54.

As mentioned above, the latch assembly 10 can also include the input member 62 (FIGS. 1A and 1B), which can be moveably mounted to the cover member 12. For instance, the input member 62 can be moveably mounted within the recess 10 of the cover member 12. Also, as mentioned above, the latch assembly 10 can have several modular configurations for accommodating different input members 62. For instance, the input member 62 can operably engage the arm engagement member 53 in some configurations such that actuation of the input member 62 linearly moves the first arm 46 (and consequently the second arm 54) from the latched position to the unlatched position. In other configurations, the input member 62 can operably engage the link engagement member 43 such that actuation of the input member 62 drivingly rotates the link 36, thereby moving the arms 46, 54 from the latched position to the unlatched position. Thus, the latch assembly 10 can be very versatile as will be discussed. Also, the latch assembly 10 can reduce manufacturing costs because, for instance, the arms 46, 54 and/or link 36 can be the same design and/or can have the same dimensions regardless of the particular modular configuration.

FIGS. 3A and 3B demonstrate a first modular configuration, wherein the input member 62 is operably engageable with the arm engagement member 53. More specifically, in the embodiments shown, the input member 62 includes a handle portion 64 that can be grasped by the user. The input member 62 can also include an attachment portion 66 that is rotatably coupled to the cover member 12, for instance, via a hinge. Thus, the input member 62 can rotate about an input axis that is substantially parallel to the Y-axis. The input member 62 can further include an input engagement member 68. The input engagement member 68 can be a projection that projects from the attachment portion 66, through the outer panel 18 of the cover member 12 and above the first arm 46, adjacent the arm engagement member 53. The input member 62 can further include a biasing member (not specifically shown) that can bias the input member 62 toward a neutral position (e.g., shown in FIG. 3A). The user can selectively rotate the input member 62 against the load supplied by this biasing member (e.g., as shown in FIG. 3B), and when the user releases the handle portion 64, the biasing member can bias the input member 62 back toward the neutral position (e.g., shown in FIG. 3A).

Operation of the latch assembly 10 will now be discussed. Assuming that the components are in the position shown in FIG. 3A, the user can pull the handle portion 64 to rotate the input member 62 relative to the cover member 12. As a result, the input engagement member 68 can rotate toward, abut, and push the arm engagement member 53 as shown in FIG. 3B. The first arm 46 can, thus, move linearly toward the housing 26 to rotate the link 36, which can consequently pull the second arm 54 toward the housing 26. The movement of the arms 46, 54 and link 36 can be at least momentarily simultaneous. As a result of this movement, the second ends 52, 60 of the arms 46, 54 can withdraw from the respective openings 22 in the base 14 to unlatch the latch assembly 10 such that the cover member 12 can be pulled away from the base 14.

Upon release of the handle portion 64, the input member 62 can be biased back toward the outer panel 18. Since the input engagement member 68 will be spaced away from the arm engagement member 53 (see FIG. 3A), the biasing member 44 can biasingly rotate the link 36, thereby biasing the arms 46, 54 linearly away from the housing 26.

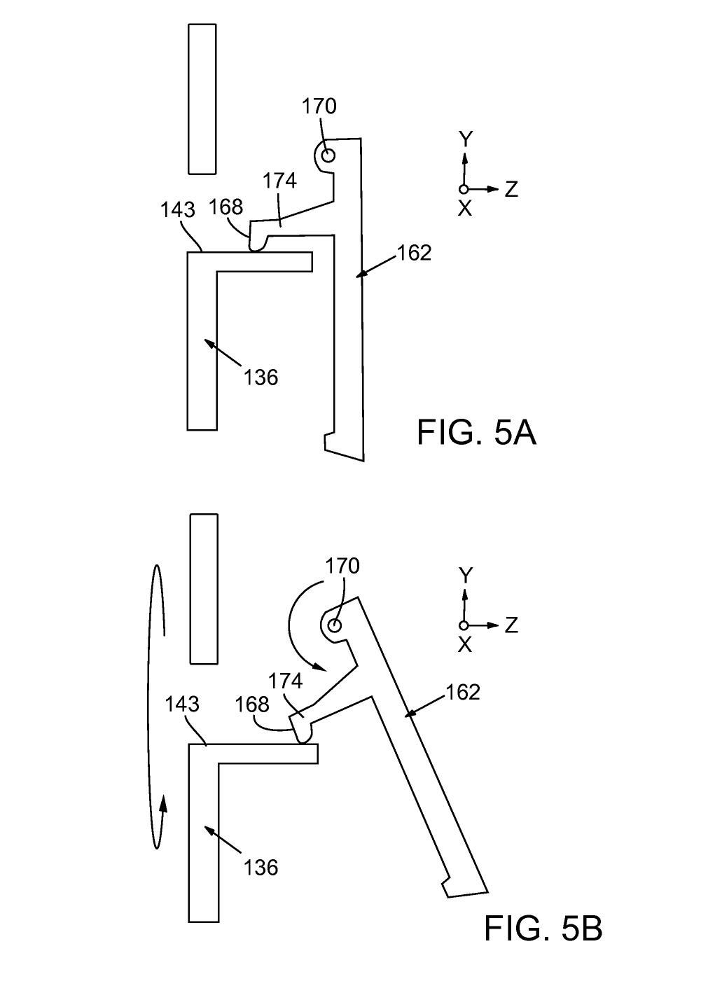

FIGS. 4, 5A, and 5B schematically illustrate another modular configuration of the latch assembly, wherein the input member 162 directly engages the link 136. For purposes of clarity, components that correspond to those of the embodiments of FIGS. 1A-3 are indicated with corresponding reference numbers increased by 100.

Like the embodiments of FIGS. 1A-3, the input member 162 can be pivotally attached to the outer panel 118. For instance, the input member 162 can be pivotally attached via a rod 170 for rotation on the outer panel 118. Also, the input member 162 can rotate about an axis that is parallel to the X-axis. Moreover, as shown in FIG. 4, a biasing member 172 can be included for rotatably biasing the input member 162 in one direction (e.g., toward the retracted position shown in FIG. 5A). In the embodiments shown, the biasing member 172 is a torsion spring; however, the biasing member 172 could be of any other type as well.

Additionally, the input member 162 can include a projection 174 that extends toward the link 136 and that terminates to define the input engagement member 168. The input engagement member 168 can include a rounded surface.

Also, like the embodiments of FIGS. 1A-3, the link engagement member 143 can be a recess, a hole, or other opening. Also, the input engagement member 168 can abut directly against the inner surface of the link engagement member 143. As shown in FIG. 5A, the inner surface (i.e., the link engagement surface) of the link engagement member 143 can extend along the Z-axis, and the link 136 can also rotate about an axis that is parallel to the Z-axis. However, as shown in FIG. 4, the inner surface of the link engagement member 143 and the axis of rotation of the link 136 can be spaced apart from each other.

Thus, as the input member 162 rotates about the axis of the rod 170, the input engagement member 168 can slide on and cam against the link engagement member 143. As a result, the link 136 can rotate about the hub 138 (FIG. 4), which can cause the arms 146, 154 to retract toward the unlatched position. Once the input member 162 is released, then the arms 146, 154 can bias back toward the latched position, similar to the previous embodiments.

Accordingly, even though the input member 62 of FIGS. 1A-3 engages the arm 4$ and the input member 162 of FIGS. 4-5B engages the link 136, the arms 46, 54, 145, 154 and the links 36, 136 can remain substantially the same. Other components, such as the housing, biasing members, etc., can also be the same, regardless of the configuration. Thus, manufacturing and assembly can be accomplished in a very efficient manner.

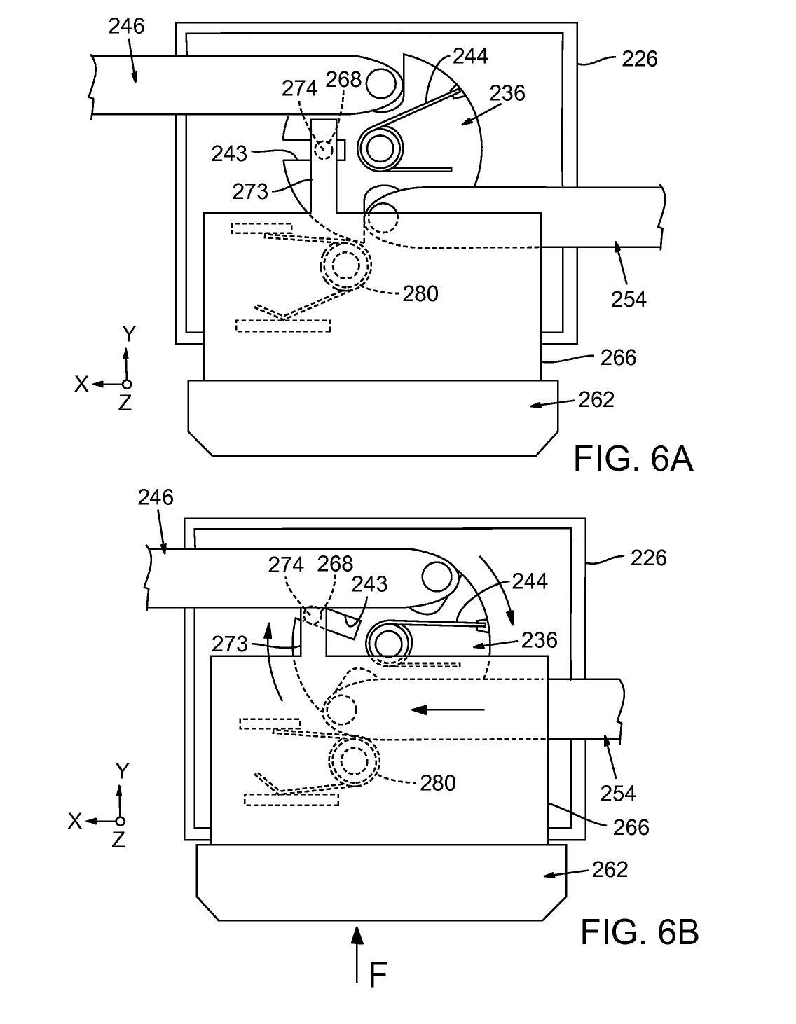

FIGS. 6A and 6B schematically illustrate another modular configuration of the latch assembly, wherein the input member 262 directly engages the link 236. For purposes of clarity, components that correspond to those of the embodiments of FIGS. 1A-3 are indicated with corresponding reference numbers increased by 200.

As shown, the input member 262 can be a pushbutton that is moveably mounted for linear movement (e.g., substantially parallel to the Y-axis). The attachment portion 266 can slidingly extend through the housing 226 and can include a flange 273 that extends parallel to the Y-axis. The attachment portion 266 can also include a projection 274 (e.g., a post) that projects transversely (e.g., parallel to the Z axis). Also, the link engagement member 243 can be a slot that extends radially inward on the link 236. The projection 274 can be moveably received within the link engagement member 243.

Thus, when the user presses the button-type input member 262 against the biasing force of the biasing member 280 (as indicated by the arrow labeled “F” in FIG. 6B), the projection 274 can push against the interior surfaces of the link engagement member 243 to thereby rotate the link 236 about its axis. This rotation of the link 236 can consequently and simultaneously pull the arms 246, 254 axially toward each other and toward the unlatched position. Once the input member 262 is released by the user, the biasing member 280 can bias the input member 262 outward, and the biasing member 244 can biasingly rotate the link 236 to thereby push the arms 246, 254 back toward the latched position.

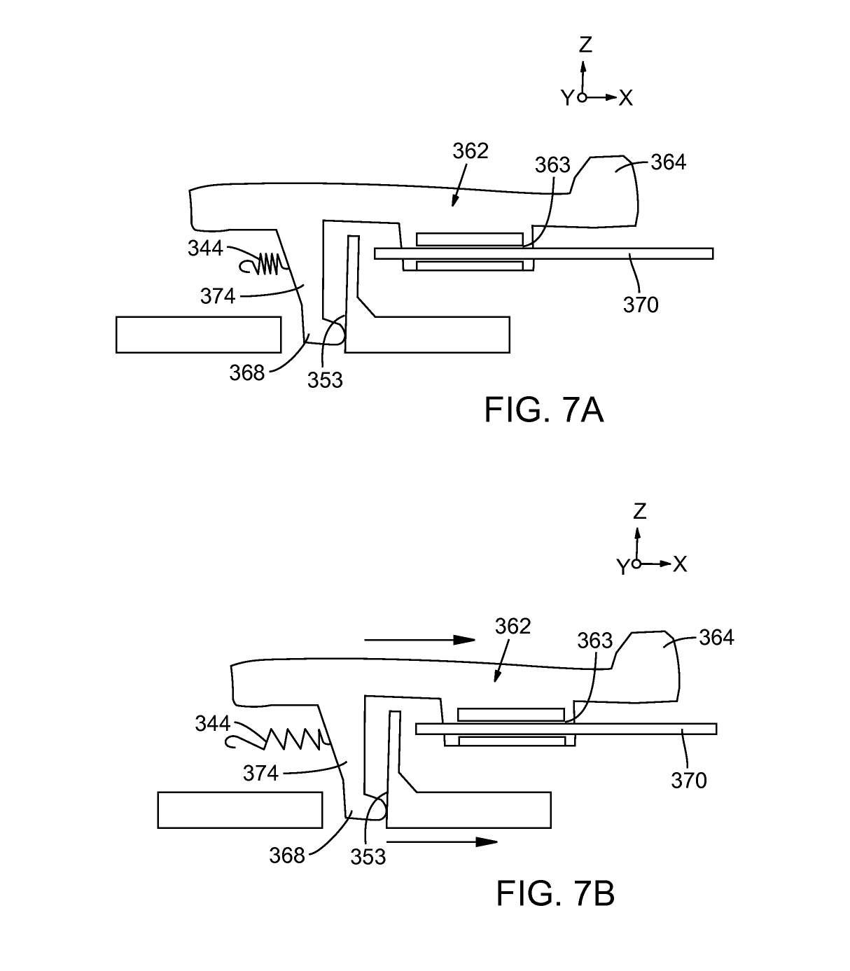

FIGS. 7A and 7B schematically illustrate another modular configuration of the latch assembly, wherein the input member 362 is a slider that can move linearly, for example, parallel to the X-axis (i.e., along an input axis). For instance, the input member 362 can also define an open-ended groove 363 that slidingly receives the rod 370, and the input member 362 can slide linearly thereon.

The input member 362 can also include a projection 374 that terminates at the input engagement member 368. The input engagement member 368 can directly engage the arm engagement member 353. In the embodiments illustrated, the arm engagement member 353 is a hole, recess, or other opening that receives the input engagement member 368.

Thus, when the input member 362 is pulled against the biasing force of the biasing member 344 along the rod 370, the input engagement member 368 can push against the interior of the arm engagement member 353 to push the corresponding arm toward the unlatched position. It will be appreciated that the input member 362 and the arm can move substantially parallel to each other as indicated by two horizontal arrows in FIG. 7B.

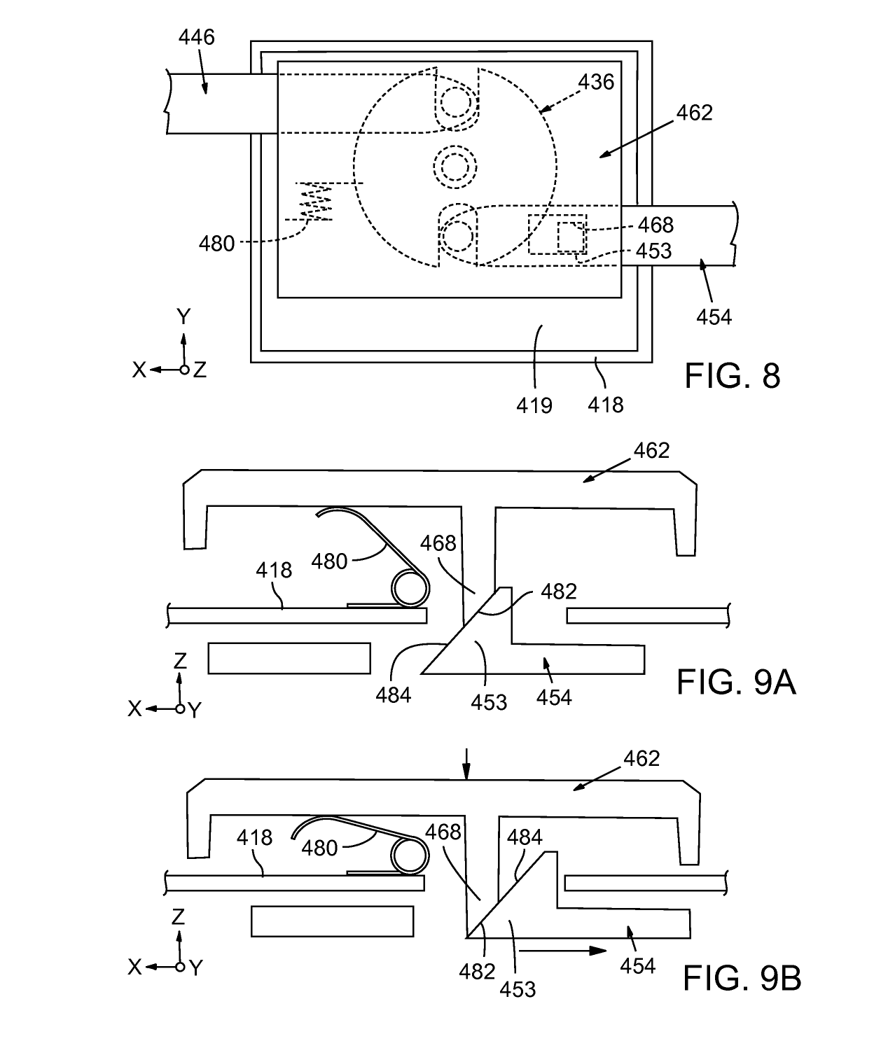

Finally, FIGS. 8, 9A, and 9B schematically illustrate another modular configuration of the latch assembly, wherein the input member 462 directly engages the arm 454. For purposes of clarity, components that correspond to those of the embodiments of FIGS. 1A-3 are indicated with corresponding reference numbers increased by 400.

As shown, the input member 462 can be a pushbutton that moves linearly (e.g., parallel to the Z-axis). The input member engagement member 468 can project toward the arm 454 and terminate at a ramp surface 482. The ramp surface 482 can be disposed at an acute angle relative to the X-axis in the X-Z plane.

Furthermore, the arm engagement member 453 can include a complimentary ramp surface 484 that can slidingly engage the ramp surface 282 of the input engagement member 468. Thus, when the input member 462 is pushed inward along the Z-axis, the ramp surface 468 can travel and slide along the face of the ramp surface 484. As a result, the arm 454, link 436, and arm 446 can actuate as discussed above.

Accordingly, the modular latch assembly of the present disclosure can include basic parts, such as the link, the arms, the housing, the fasteners, bumpers, etc. can remain the same regardless of the configuration. Thus, the latch assembly can be manufactured and assembled efficiently.

The latch assembly can also be varied from the illustrated embodiments. For, instance, several examples are illustrated and described wherein a projection is received within an opening for engaging two separate parts. As a specific example, the projection 274 is received within the link engagement member 243 of FIGS. 6A and 6B. However, it will be appreciated that the arrangement could be reversed such that the link engagement member 243 could be a projection that is received within an opening of the input member 262 without departing from the scope of the present disclosure. Other embodiments can be similarly arranged. For instance, the projection 374 of the input member 362 is received within the arm engagement member 353 in FIGS. 7A and 7B, but these embodiments can be modified such that the arm engagement member 353 is received within a recess of the input member 362 without departing from the scope of the present disclosure.

What is claimed is:

1. A modular latch assembly for selectively securing a cover member to a base due to actuation of an input member, the input member including an input engagement member comprising:
an arm that is supported for substantially linear movement between a latched position and an unlatched position, the arm securing the cover member to the base when in the latched position, the arm releasing the cover member from the base when in the unlatched position, the arm including an arm engagement member; and
a link that is operably coupled to the arm for rotation relative to the arm simultaneously as the arm moves between the latched and unlatched positions, the link including a link engagement member,
the arm and the link having a first modular configuration in which the arm engagement member is configured to engage the input engagement member due to selective actuation of the input member, thereby resulting in simultaneous movement of the arm between the latched and unlatched positions and rotation of the link,
the arm and the link having a second modular configuration in which the link engagement member is configured to engage the input engagement member due to selective actuation of the input member, thereby resulting in simultaneous movement of the arm between the latched and unlatched positions and rotation of the link.

2. The modular latch assembly of claim 1, further comprising a biasing member that biases the arm toward the latched position.

3. The modular latch assembly of claim 1, wherein the link rotates about a link axis, and wherein the link engagement member includes a link engagement surface that is substantially parallel to and spaced at a distance from the link axis.

4. The modular latch assembly of claim 3, wherein the input member is configured to be mounted for rotation on the cover member, and wherein in the second modular configuration the input engagement member cams on the link engagement surface to rotate the link as the input member rotates.

5. The modular latch assembly of claim 1, wherein the input member is configured to be mounted for rotation on the cover member, wherein the arm engagement member includes an arm projection that projects from the arm, and wherein in the first modular configuration the input engagement member abuts against the arm projection as the input member rotates.

6. The modular latch assembly of claim 1, wherein the link engagement member includes one of an opening and a projection, wherein the input engagement member includes the other of the opening and the projection, and wherein in the second modular configuration the projection is received within the opening.

7. The modular latch assembly of claim 6, wherein the input member is configured to be mounted for substantially linear movement on the cover member.

8. The modular latch assembly of claim 1, wherein the arm engagement member includes one of an opening and a projection, wherein the input engagement member includes the other of the opening and the projection, and wherein in the first modular configuration the projection is received in the opening.

9. The modular latch assembly of claim 8, wherein the input member is configured to be mounted for substantially linear movement along an input axis on the cover member, wherein the arm moves substantially linearly along an arm axis, the arm axis and the input axis being substantially parallel to each other.

10. The modular latch assembly of claim 1, wherein the arm engagement member includes a first ramp surface, wherein the input engagement member includes a second ramp surface that is complimentary to the first ramp surface, wherein in the first modular configuration the second ramp surface slides along against the first ramp surface.

11. A modular latch assembly for selectively securing a cover member to a base due to actuation of an input member, the input member including an input engagement member comprising:
a first arm and a second arm that are supported for substantially linear movement in different directions between a latched position and an unlatched position, the first and second arms securing the cover member to the base when in the latched position, the first and second arms releasing the cover member from the base when in the unlatched position, at least one of the first and second arms including an arm engagement member; and
a link that is operably coupled to the first and second arms for rotation relative to the first and second arms simultaneously as the first and second arms move between the latched and unlatched positions, the link including a link engagement member,
the first and second arms and the link having a first modular configuration in which the arm engagement member is configured to engage the input engagement member due to selective actuation of the input member, thereby resulting in simultaneous movement of the first and second arms between the latched and unlatched positions and rotation of the link,
the first and second arms and the link having a second modular configuration in which the link engagement member is configured to engage the input engagement member due to selective actuation of the input member, thereby resulting in simultaneous movement of the first and second arms between the latched and unlatched positions and rotation of the link.

12. The modular latch assembly of claim 11, further comprising a biasing member that biases the first and second arms toward the latched position.

13. The modular latch assembly of claim 11, wherein the link rotates about a link axis, and wherein the link engagement member includes a link engagement surface that is substantially parallel to and spaced at a distance from the link axis.

14. The modular latch assembly of claim 13, wherein the input member is configured to be mounted for rotation on the cover member, and wherein in the second modular configuration the input engagement member cams on the link engagement surface to rotate the link as the input member rotates.

15. The modular latch assembly of claim 11, wherein the input member is configured to be mounted for rotation on the cover member, wherein the arm engagement member includes an arm projection that projects from the at least one of the first and second arms, and wherein in the first modular configuration the input engagement member abuts against the arm projection as the input member rotates.

16. The modular latch assembly of claim 11, wherein the link engagement member includes one of an opening and a projection, wherein the input engagement member includes the other of the opening and the projection, and wherein in the second modular configuration the projection is received within the opening.

17. The modular latch assembly of claim 16, wherein the input member is configured to be mounted for substantially linear movement on the cover member.

18. The modular latch assembly of claim 11, wherein the arm engagement member includes one of an opening and a projection, wherein the input engagement member includes the other of the opening and the projection, and wherein in the first modular configuration the projection is received in the opening.

19. The modular latch assembly of claim 18, wherein the input member is configured to be mounted for substantially linear movement along an input axis on the cover member, wherein the first and second arms both move substantially parallel to an arm axis, the arm axis and the input axis being substantially parallel to each other.

20. The modular latch assembly of claim 11, wherein the arm engagement member includes a first ramp surface, wherein the input engagement member includes a second ramp surface that is complimentary to the first ramp surface, wherein in the first modular configuration the second ramp surface slides along the first ramp surface.
